(19) United States
(12) Patent Application Publication
(10) Pub. No.: US 2004/0091759 A1
(43) Pub. Date: May 13, 2004

(54) Methods and apparatus for indicating a fault condition in fuel cells and fuel cell components

(76) Inventors: David Athol Harrington, Victoria (CA); Walter Roberto Merida Donis, Vancouver (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/440,264

(22) Filed: May 19, 2003

Related U.S. Application Data
(60) Provisional application No. 60/380,840, filed on May 17, 2002.

(51) Int. Cl. H01M 8/04; G06F 11/00

(52) U.S. Cl. 429/22; 714/48

(57) ABSTRACT

An apparatus and methods for detecting and identifying faults in a fuel cell are disclosed. An impedance spectrum relating to the fuel cell is compared with fault criteria to identify fault conditions in the fuel cell. A time-varying current is drawn from the fuel cell at a selected frequency and the impedance of the fuel cell at the frequency is measured. This may optionally be repeated at a range of frequencies or at combinations of frequencies to provide an impedance spectrum across the range of frequencies. The fault criteria identify one or more fault conditions that may be identified by comparing the measured impedance spectrum to the fault conditions.

### FIELD OF THE INVENTION

This invention relates to methods and apparatus for indicating fault conditions in fuel cells, fuel cell stacks, fuel cell systems and/or fuel cell components.

### DESCRIPTION OF RELATED ART

Fuel cells are electrochemical energy conversion devices that combine a fuel and an oxidant and convert a fraction of the chemical energy in these components into useful electrical power. When pure hydrogen is used as a fuel, the only by-products are heat and water.

Fuel cells generally have of two electrodes referred to as an anode and a cathode, respectively, separated by an ionic conductor. The ionic conductor must have low gas permeability and low electronic conductivity. The electrodes are layered and porous structures, permeable to liquids or gases and are connected to an electrical circuit. A fuel and an oxidant are delivered to either side of the fuel cell and fuel molecules are oxidized and dissociated at the anode. Resulting electrons flow through an external circuit and can be used to power an electrical load. A current of equal magnitude flows in the fuel cell by virtue of charge carriers within the ionic conductor. Typical charge carriers include hydronium ions in an acidic medium, hydroxyl ions in an alkaline medium and mobile ionic species present in solid ionic conductors.

At the cathode, the electrons reduce the oxidant and recombine with the ionic species to produce a final reaction product such as water, for example.

In theory any substance capable of undergoing chemical oxidation can be used as fuel. Similarly, any substance can be an oxidant if it can be reduced at a sufficiently high rate. However, practical systems are limited to a few fuel choices, such as hydrogen natural gas and methanol and usually use the oxygen present in air as the oxidant stream. The overall fuel cell reaction is the same reaction that would have occurred if hydrogen had been ignited in the presence of oxygen. However, the energy produced in this manner corresponds to the enthalpy change between reactants and products. Therefore, useful work must be provided by sequential conversions into thermal energy. All these conversions are limited by the heat transfer properties of real structural materials within the fuel cell. By releasing the chemical energy of the fuel in the form of a directed flow of electrons, fuel cells make it possible to achieve higher efficiencies without large temperature differences.

In general, all fuel cells have failure modes, some of which are specific to the particular type of fuel cell under consideration. For example, proton exchange membrane fuel cells (‘PEMFCs’) are a type of fuel cell that typically operate below the normal boiling point of water and use a solid polymer membrane as the ionic conductor. This membrane also acts as an electronic insulator between the two electrodes and as an impermeable barrier separating the reactant gases. PEMFCs operate at relatively low temperatures and have no liquid electrolytes which gives them the ability to operate in any orientation. These characteristics make PEMFCs the preferred choice for vehicular and portable applications.

The presence of water within the polymeric ionic conductor (membrane) is indispensable for PEMFC operation. However, water present in other regions of the cell, such as gas diffusion layers or flow field channels, can have a negative impact on cell performance by hindering access of reactants to catalyst sites within the fuel cell. Therefore, PEMFC operation requires a careful balance between the presence and removal of excess water from the fuel cell.

In addition, operating parameters such as flow rates, humidity, temperature, and pressure affect the generation of water in PEMFC fuel cells and are highly coupled. Different combinations of these parameters can affect the performance of the fuel cell in similar ways and thus, it is difficult to discern their separate contributions or detrimental effects on performance.

In connection with the effects of water on PEMFCs, membrane dehydration results in a dramatic change in morphology and material properties. When this occurs, there is a reduction in the size of the ionic clusters and the width of the interconnecting channels within the microstructure of the polymer acting as the membrane. Channels constrict the flow of hydrated ions in the membrane and protonic mobility is reduced resulting in an increase in ohmic resistance through the membrane. This results in ohmic heating and imposes additional thermal stresses on dehydrated regions of the membrane. These regions become depleted of water more rapidly with rising temperatures. In extreme cases water will be completely removed and local temperature will rise above the glass transition temperature or melting point of the membrane. Under these conditions, usually known as brown-outs, regions of the polymer can burn and rupture. The effects of this type of failure are that the ionic conductor is irreversibly damaged and the effectiveness of the membrane on reactant separation is compromised.

A ruptured polymer can create a pneumatic short circuit between oxidant and fuel. This is particularly catastrophic for serial, high current applications where the geometric power densities are high. This could occur in vehicular power plants operating at 0.5 Watts per cm² per cell, or more, for example. Failures of this type in one cell within a serial PEMFC stack will halt current production for the entire stack and more importantly could present a safety hazard as oxidant and fuel may be mixed at high temperatures and in the presence of an active catalyst, could result in potentially explosive fuel ignition. The longevity and reliability of the affected module can also be compromised. Membranes that recover from drying out before catastrophic failure will still suffer from performance degradation as the microstructures in the membrane become altered slowly and cumulatively. Macroscopic physical deformation, such as catalyst layered delamination, can occur after partial sudden drying and dehumidification. Polymers may also become brittle. Finally, some macroscopic and microscopic interfacial characteristics, such as contact resistance, may change due to changes in geometry such as membrane thickness variations under constant compressive forces but varying water content. Membrane dehydration can be irreversible and often results in maintenance down time and added expense. Most high power applications require serial configurations, so replacing single cells usually requires disassembly or replacement of entire modules.

Excess water in the porous layers of a PEMFC can also be a problem. Operating a PEMFC at moderate or high current densities and with fully humidified reactants can result in water accumulation at the cathode, known as flooding, especially within the gas diffusion layer of the fuel cell. The presence of liquid water leads to two-phase flow that can hinder reactant transport to catalyst sites. Macroscopic water layers can result in preferential flow through alternative channels and the subsequent reduction in the local partial pressure of reactants in blocked channels.

Dehydration and flooding events both result in direct current (‘DC’) voltage drops across a PEMFC fuel cell, however, from measurements of voltage alone one cannot determine whether degradation of the fuel cell is due to dehydration or flooding. The wrong diagnoses and subsequent application of inappropriate remedies can exacerbate the failure. For example, flooding can be moderated by increasing the flow stoichiometry. However, larger flows represent larger drying rates. Hence, a drying event can mistakenly be diagnosed as a flooding failure and vice versa.

Generally, in most fuel cell applications cell potential is used as a performance indicator of a fuel cell or fuel cell stack. Accordingly, existing monitoring strategies measure individual module or cell voltages in a stack. Since a drop in the cell potential can be the result of many competing and concurrent mechanisms, DC measurements are usually insufficient to determine the cause of a failure in any type of fuel cell. What is desired therefore, is a way of determining specific fault conditions in fuel cells.

### SUMMARY OF THE INVENTION

The present invention addresses the above need by providing a method and apparatus for indicating a fault condition in a fuel cell, fuel cell stack or other fuel cell components such as membranes, electrodes and membrane electrode assemblies (MEAs). All such devices are generically referred to herein as fuel cells.

The method and apparatus involve producing a fault condition signal indicating one or more specific fault conditions when one or more property of an impedance spectrum of the fuel cell meets one or more criterion associated with the specific fault condition.

Producing a signal may involve receiving a representation of the property or properties of the impedance spectrum. Receiving may involve receiving the representation from a frequency response analyzer.

Producing may also involve producing a representation of the property or properties of the impedance spectrum. This may involve producing a representation of a ratio of a measured impedance value to a reference impedance value. This ratio may be of a measured impedance value to a reference impedance value associated with a perturbation signal having a particular frequency or may be of a measured phase value to a reference phase value. Producing may further involve determining whether the ratio meets the criteria associated with the specific fault condition.

In another embodiment producing a representation may involve producing a representation of a ratio of a measured impedance value to a reference impedance value for each of a plurality of frequencies in a frequency band. The ratio may be produced for an impedance measured at a frequency between about 1 kHz to about 4 kHz, for example, and/or the ratio may be produced for an impedance measured at a frequency between about 0.5 Hz to about 100 Hz, for example. The ratio may be produced for impedances in different spectral ranges, including spectral range of less than 0.1 Hz and more than several hunder MHz. Similarly, the ratio may be of a measured impedance value to a reference impedance value for two or more distinct frequencies.

The representation of the property or properties of the impedance spectrum may be a ratio of a measured phase value to a reference phase value or a difference between a measured phase value and a reference phase value. Alternatively, the representation may relate to another characteristic of the impedance of the fuel cell.

The fault condition signal may be used to indicate the presence of a drying effect within the fuel cell and/or the signal may be used to indicate the presence of a flooding effect in the fuel cell.

The signal associated with the drying effect may be produced when the ratio for an impedance measured at a frequency of between about 1 kHz and about 4 kHz is outside of a predefined range. The signal associated with the flooding effect may be produced when the ratio for an impedance measured at a frequency between about 0.1 Hz and about 100 Hz is outside of a range.

Different criteria may be associated with different specific fault conditions and the method may involve determining whether at least one of the different criteria is met. The method may further involve producing different signals for correspondingly different fault conditions. The method may further involve producing signals indicative of respective fault conditions when corresponding criteria associated with the respective fault conditions are met and may further involve measuring an impedance of the fuel cell at at least one frequency. The method may alternatively involve measuring the impedance of the fuel cell across a range of frequencies or at a plurality of different frequencies.

Measuring the impedance of the fuel cell may involve maintaining a constant DC load on the fuel cell and sweeping a frequency range of a periodic perturbation signal of constant amplitude affecting the load on the fuel cell while measuring current and voltage across the fuel cell. The method may involve electro-chemical impedance spectroscopy.

In accordance with another aspect of the invention, there is provided a method of indicating a fault condition in a fuel cell, the method comprising receiving at least one representation of a measured impedance measured at a measurement frequency, identifying at least one measured impedance representation measured at a measurement frequency associated with a fault criterion and producing a signal indicative of the fault condition when the at least one measured impedance value meets the fault criterion.

In accordance with another aspect of the invention, there is provided a method of measuring the impedance of a fuel cell. The method involves adjusting the impedance of a perturbation load coupled to a work load receiving energy from the fuel cell, to produce a periodic variation in net load to the fuel cell while measuring voltage across the fuel cell and current through the fuel cell. Adjusting may involve adjusting the impedance of a perturbation load parallel-coupled to the work load.

In accordance with another aspect of the invention, there is provided a method of measuring impedance of a fuel cell. The method involves producing a control signal having a periodic property and coupling the control signal to a perturbation load coupled to a work load receiving energy from the fuel cell, to produce a periodic variation in net load to the fuel cell, while measuring voltage across the fuel cell and current through the fuel cell.

Another embodiment of the invention provides an apparatus for identifying fault conditions in a fuel cell or fuel cell component, the apparatus comprising: an impedance spectrum input for receiving an impedance spectrum relating to the fuel cell; a processor coupled to the input for comparing the impedance spectrum with at least part of a fault criteria, wherein the processor determines that a fault condition exists when one or more properties of the impedance spectrum meets the fault criteria; and an alarm output for providing a fault condition signal when a fault condition exists.

The apparatus may have a fault criteria input for receiving the fault criteria. The fault criteria may be stored on a computer readable medium readable by a media reader. The media reader may be coupled to the fault criteria input for providing the fault criteria to the processor.

The alarm output may be coupled to an alarm annunciator that is responsive to the fault condition signal to indicate when a fault condition exists. The annunciator may be one or more of a visible indicator such as a lamp or LED or computer display, an audible alarm or a display readable by an observer. The annunciator may provide different indications in response to different fault conditions. The apparatus may be configured to respond to the fault condition signal to remove or reduce the fault or alter the state of the fuel cell system in an appropriate way.

The processor of the apparatus may be one or more comparators.

The apparatus may further comprise an impedance spectrum measurement circuit coupled to the impedance spectrum input to provide the impedance spectrum.

The fault criteria may include an impedance relative to a reference impedance relating to a single frequency, a range of frequencies, a plurality of frequencies, or a combination of frequencies.

When the apparatus is used with a PEMFC, the fault criteria may include impedances relative to reference impedances in frequency range of about 0.5 Hz to about 100 kHz for identifying dehydration effects or may include impedances relative to reference impedances in frequency range of about 0.5 Hz to about 100 Hz for identifying flooding effects, or may include impedances relative to reference impedances in both of these ranges to identify both types of faults.

The impedance spectrum measurement circuit includes: an impedance measuring device having a control signal output for providing a control signal to the fuel cell, a voltage input for measuring the voltage across fuel cell and a current input for receiving a measure of current flowing through a current sensing element coupled in series with the fuel cell; a computer coupled to the impedance measuring device, wherein the computer is programmed to calculate the impedance spectrum, wherein the computer is coupled to the impedance spectrum input to provide the calculated impedance spectrum to the processor; and a load for coupling to the fuel cell, wherein the load is responsive to the control signal to vary the current drawn from the fuel cell.

The impedance measuring device may be a frequency response analyzer, a lockin amplifier or a or a data acquisition device using a fourier transform of the fuel cells impedance.

The current sensing element may be a resistor, a Rogowski coil or a current transformer.

The load of the apparatus will typically draw a time-varying current from the fuel cell, and typically, the frequency of the time-varying current will correspond to the control signal.

The load will typically be a perturbation load coupled to the fuel cell in conjunction with a fixed load such that both the perturbation load and the fixed load draw current from the fuel cell.

The apparatus may further comprise an isolation circuit coupled to the control signal output for electrically isolating the control signal output from the fuel cell.

In another aspect, the apparatus may further comprise: load connection terminals for coupling the load to the fuel cell; voltage connection terminals for coupling the voltage input to the fuel cell; and current connection terminals for coupling the current input across the current sensing element. These terminals may be used to couple the apparatus to an external fuel cell. Alternatively, the apparatus may be assembled integrally with a fuel cell.

In another embodiment, the present invention provides, in a system incorporating a fuel cell or a fuel cell component, an apparatus for identifying faults in the fuel cell or fuel cell component, the apparatus comprising: an impedance spectrum input for receiving an impedance spectrum relating to the fuel cell; a processor coupled to the input for comparing the impedance spectrum with at least part of a fault criteria, wherein the processor determines that a fault condition exists when one or more properties of the impedance spectrum meets the fault criteria; and an output for providing a fault condition signal when a fault condition exists. The system is responsive to the fault condition signal to stop or modify usage of the fuel cell when a fault condition exists. The system may be a fuel cell testing system and may be configured to stop testing of the fuel cell in response to the fault condition signal.

In another embodiment, the present invention provides a method of identifying a fault condition in a fuel cell or a fuel cell component comprising, the method comprising: receiving an impedance spectrum relating to the fuel cell; selecting an aspect of the impedance spectrum for comparison with at least part of a fault criteria; comparing the selected aspect of the impedance spectrum with a corresponding portion of the fault criteria; and if the selected aspect of the impedance spectrum meets the fault criteria, then providing a fault condition signal.

The fault criteria may include criterion relevant to different fault conditions and the fault condition signal may identify one or more existing fault conditions in the fuel cell.

The method may further comprise applying a time varying load to the fuel cell, wherein the load has a selected frequency and measuring an impedance property of the fuel cell at the selected frequency to calculate the impedance spectrum. The impedance spectrum may relate to the impedance of the fuel cell at a specific frequency, at a range of frequency, at a plurality of frequencies or at a combination of frequencies.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of an apparatus according to a first embodiment of the invention;

FIG. 2 is a block diagram of a processor circuit of the apparatus shown in FIG. 1;

FIG. 3 is a flowchart of a routine executed by the processor circuit shown in FIG. 2;

FIG. 4 is a system for measuring impedance of a fuel cell in accordance with one embodiment of the invention;

FIG. 5 is a system for measuring impedance of a fuel cell according to a second embodiment; and

FIG. 6 is an impedance plot of an impedance spectrum of a fuel cell illustrating regions in which flooding effects and dehydration effects can be detected.

### DETAILED DESCRIPTION OF EXEMPLARY EMBODIMENTS

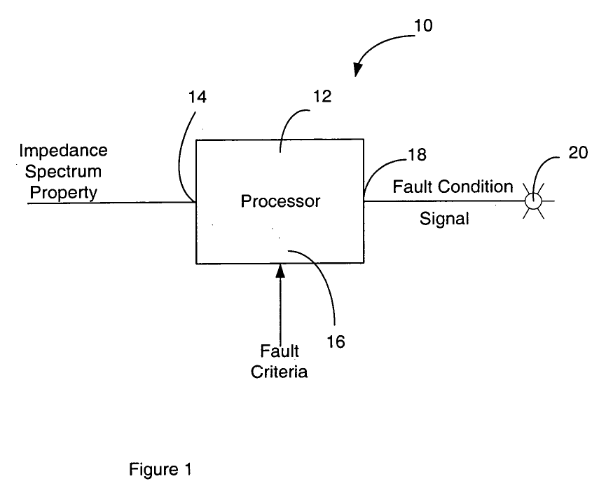

Referring to FIG. 1, an apparatus for indicating a fault signal in a fuel cell, according to a first embodiment of the invention, is shown generally at 10. In this embodiment the apparatus includes a processor 12 having an input 14 for receiving an impedance spectrum property and has a second input 16 for receiving fault criteria. The processor also has an output 18 at which it produces a fault condition signal indicating a specific fault condition when the property of the impedance spectrum received at the input 14 meets the criteria received at the input 16. The fault condition signal may be a simple on/off signal used to control an indicator lamp such as shown at 20, for example. In general, the fault condition signal may be used to control any type of annunciator for alerting an operator of a fault condition or may be used to initiate a process for alerting an operator.

By appropriate input of fault criteria and appropriate input of an impedance spectrum property, the apparatus 10 may be used to produce fault condition signals to indicate faults such as dehydration, flooding, increased contact resistance, loss of perimeter seals, catalyst poisoning, changes in ionic conductivity, or changes in electrode substrate thickness, for example, in any type of fuel cell.

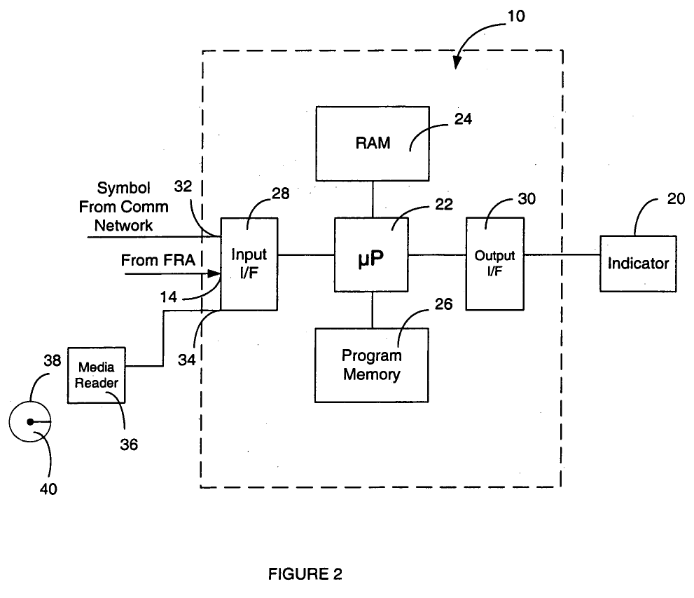

Referring to FIG. 2, the apparatus 10 may be implemented as a processor circuit comprised of a processor 22 in communication with random access memory 24, program memory 26, an input interface 28 and an output interface 30. The input interface 28 in this embodiment includes the first input 14 for receiving the impedance spectrum property. In this embodiment, however, the input interface 28 also has second and third inputs 32 and 34, respectively. The second input 32 is operable to receive a signal from a communications network, for example, and the third input 34 is connected to a media reader 36 operable to read a computer readable medium such as a CD-ROM 38.

The CD-ROM 38 may contain codes 40 readable by the media reader 36 and storable in the program memory 26 for directing the processor 22 to cause the signal indicating the specific fault condition to be produced when a property of the impedance spectrum meets a corresponding criteria associated with the specific fault condition. Alternatively, codes for achieving this function may be received from the communications network at the input 32 such as from a signal received from the Internet, for example. These codes could also be stored in the program memory 26 to achieve the same result.

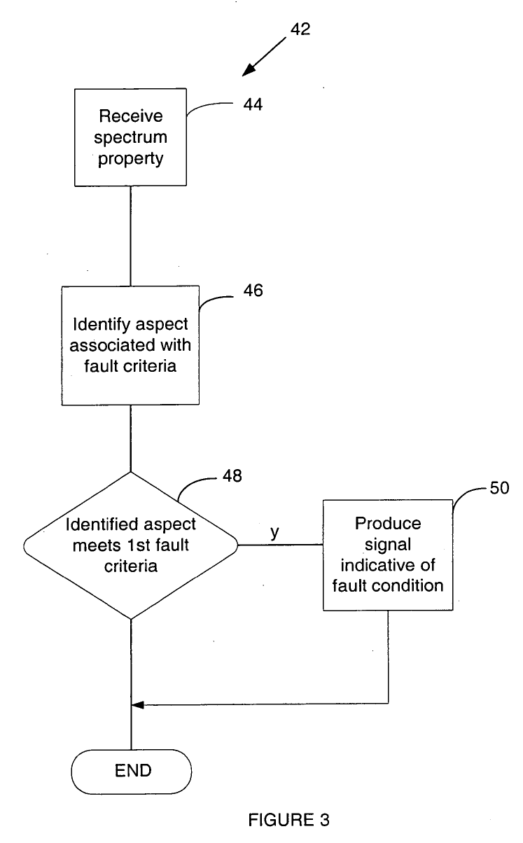

Referring to FIG. 3, the program codes may include blocks of codes shown generally at 42 in FIG. 3, which co-operate to implement a routine by which the processor 22 is directed to produce the signal indicating the specific fault condition. In this regard, the codes include a first block 44 that directs the processor 22 to receive the spectrum property from the input 14, shown in FIG. 2. Block 46 then directs the processor 22 to identify an aspect of the spectrum property that is to be used for comparison with a first set of criteria for determining whether or not a fault condition exists. This first set of criteria may be hard-coded or pre-stored in the program memory 26, for example, or may be a soft value received and stored in the RAM 24.

Referring back to FIG. 3, block 48 directs the processor 22 to determine whether or not the identified aspect of the spectrum property meets the first criteria. If so, block 50 directs the processor circuit 10 to produce a signal indicative of the fault condition associated with the first criteria. To do this, the processor 22 may simply write a bit to a register of the output interface 30 and the output interface may supply a digital signal to the indicator 20 to cause the indicator to indicate to the user that the fault condition exists. It will be appreciated that the indicator may alternatively be an audible indication or any other physical stimulus recognizable by an observer.

Alternative embodiments (not shown) may implement the functionality of the processor 22 using analog circuitry including a comparator or a plurality of comparators, for example.

The apparatus 10 may be configured to receive any, some or all of various properties of an impedance spectrum. For example, the impedance spectrum property may simply be a signal or a computer bit, byte, word or file, for example, indicating an impedance measured at a particular frequency. In this situation, the fault criteria may include a range, or multiple ranges, of impedance values. Block 48 of FIG. 3 then would involve determining whether or not the measured impedance value falls within the range and, if so, to cause the signal indicative of a fault condition to be produced.

In accordance with another embodiment, the impedance spectrum property may be a ratio of a measured impedance value to a reference impedance value, a ratio of a measured phase value to a reference phase value or a difference between a measured phase and a reference phase value and these values (i.e. the ratio or difference) may be represented by a bit, byte, word or file, for example, and received at the input 14, shown in FIGS. 1 and 2. In this situation, the fault criteria may include a range of ratio or difference values with which the input spectrum property received at the input 14 is compared to determine whether or not the input spectrum property is within the range. If so, block 48 of FIG. 3 directs the processor to block 50 causing it to produce the signal indicative of a fault condition.

In another embodiment, an entire impedance spectrum over a range of frequencies, for example, may be received and the shape of the spectrum or certain points or regions of the spectrum may be compared against corresponding fault criteria to determine whether or not the fault condition signal is to be activated.

Where a plurality of impedance spectrum properties are provided as input, such as in the case where an entire impedance spectrum is received, the process of FIG. 3 may be executed in succession with different fault criteria on each pass, thereby producing a plurality of different fault signals representing respective different fault conditions associated with respective different fault criteria.

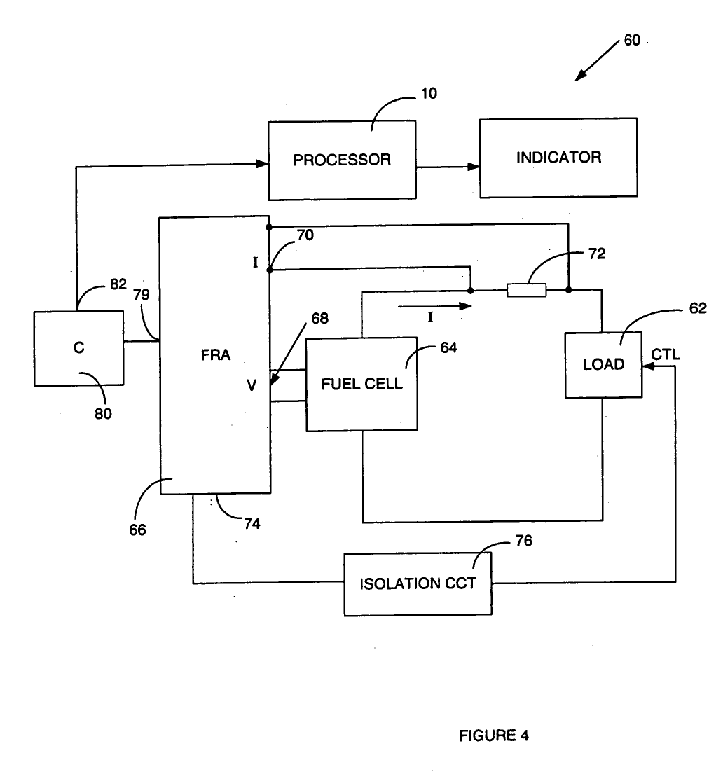

A system for measuring impedance of a fuel cell to produce a representation of a property of the impedance spectrum thereof is shown generally at 60 in FIG. 4. This system involves electrochemical impedance spectroscopy (EIS). Effectively, the current drawn by a load 62 receiving energy from a fuel cell 64 is adjusted to produce a periodic variation in net load to the fuel cell while the impedance of the fuel cell is measured. The impedance may be measured by an impedance measuring device such as a frequency response analyzer 66 having a voltage input shown generally at 68 for measuring voltage across the fuel cell and a current input shown generally at 70 for receiving a measure of current through a current sensing resistor 72 in series with the fuel cell 64 and the load 62. The impedance of the fuel cell may be calculated as

$$Z = \frac{V}{I}$$

where V and I are complex numbers representing both phase and magnitude of the voltage and current, respectively.

Current sensing resistor 72 is an example of various types of devices that may be used as a current sensing element. Other devices, such as a Rogowski coil or current transformer may also be used.

In this embodiment the frequency response analyzer 66 may be a Solartron 1255B Frequency Response Analyzer. This device has a signal generator output 74 at which it generates a control signal having a periodic property. For example, in this embodiment the control signal may be a sinewave having a frequency and the frequency analyzer has the capability of sweeping this frequency between about 0.1 Hz to about 100 kHz to produce impedance spectrum properties for detecting dehydration and flooding in PEMFC fuel cells with NAFION™ membranes. The amplitude of the control signal will typically be selected based on the input levels required to control the load 62. In one embodiment, the load is responsive to a control signal with an amplitude of 0 to 10 volts.

Other spectral ranges, extending below 0.1 Hz and above 100 kHz may be used to identify other properties of PEMFC and other types of fuel cells. For example, spectral ranges up to several hundred MHz may be used. In general, the frequency range used will depend on the fuel cell type, construction or configuration and failure mode to be detected.

Other devices capable of calculating frequency impedance spectra may be used in place of the frequency response analyzer. Any device (or combination of devices) capable of providing a control signal and measuring the impedance of the fuel cell may be used to produce an impedance spectrum. For example, a lockin amplifier or a data acquisition device using a fourier transform of the acquired data may be used to measure the impedance of the fuel cell.

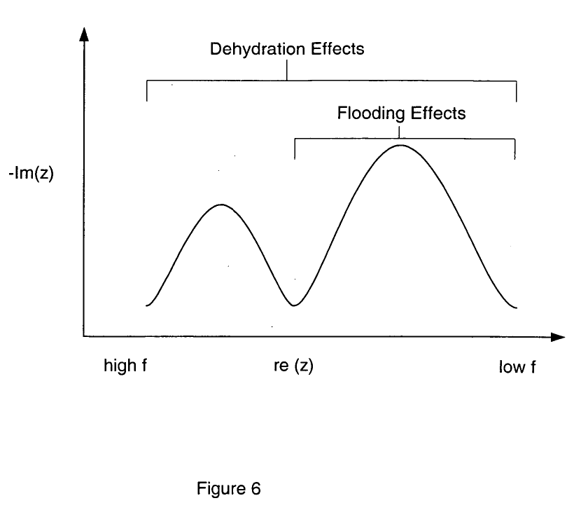

Referring to FIG. 6, dehydration effects in proton exchange membrane fuel cells (PEMFCs), for example, may be detectable in changes in impedances relative to reference values in a frequency range of about 0.5 to about 100 kHz, whereas flooding effects in PEMFCs may be detectable in changes in impedances relative to reference values in a frequency range of about 0.5 to about 100 Hz. Thus, separate or concurrent impedance measurements in distinct frequency ranges or bands of frequency ranges can be used to discern and identify dehydration and flooding conditions in a fuel cell. Other separate or concurrent impedance measurements in other distinct frequency ranges can be used to discern and identify other fault conditions such as those mentioned above.

In other embodiments of the invention, an impedance spectrum property of a fuel cell in response to a multi-frequency load having frequency components at two or more frequencies, or frequency ranges, may be used. For example, the load 62 may be configured to draw a current from the fuel cell with a frequency component at 5 Hz and another component at 10 kHz. Typically, although not necessarily, this will be done by generating a control signal having the desired frequency components. The impedance spectrum property of the fuel cell in response to the multi-frequency load may be measured and compared to known fault conditions relating to the property.

Referring again to FIG. 4, the signal produced at the output 74 is provided to an isolation circuit 76 which may include a voltage follower, for example, to minimize ground loops and potential errors in DC levels due to voltage drift during measurements. The isolation circuit produces a signal that is received at the load 62 and controls the impedance of the load to adjust current therethrough by a perturbation amount of a few percent of the main load current. For example, an alternating current (AC) perturbation of approximately ±0.5 amperes may be used with a direct current (DC) load of 30 amperes. As another example, an AC perturbation of 3 amperes may be used with a DC load of 240 amperes. These value are merely exemplary and do not limit the scope of the invention. Thus, the frequency response analyzer varies the impedance of the load 62 to alter current therethrough within a range of about +0.5 amperes relative to a nominal load current. This causes the fuel cell 64 to supply a current with a periodically varying component relative to a nominal current supply value. This current and the voltage produced by the fuel cell 64 are measured at the inputs 70 and 68, respectively.

The frequency response analyzer 66 may be operated to produce control signals at the output 74 at specific, individual frequencies to produce corresponding specific individual impedance values associated with those specific frequencies or may be operated to sweep a range of frequencies to produce a corresponding range of impedance values to produce a representation of an impedance spectrum of the fuel cell.

The frequency response analyzer 66 has an interface 79 that is connected to a computer 80. The computer 80 may be programmed to run commercial EIS software packages such a ZPLOT™ and ZVIEW™ available from Scribner Associates Inc. of North Carolina, U.S.A., which control the frequency response analyzer to cause it to provide data to the computer, for analysis by the EIS software package to produce an impedance spectrum or an individual impedance value or a ratio of a measured impedance value to a reference impedance value or a ratio of a measured phase value to a reference phase value or a difference between a measured phase value and a reference phase value, for example. Any of the above may be referred to as a property of the impedance spectrum of the fuel cell.

EIS software packages, such as those identified above, may also be used to analyze the impedance spectrum of a fuel cell to provide an equivalent circuit for the fuel cell. The magnitude of components (i.e. resistor, capacitor, inductors, etc.) in an equivalent circuit for a fuel cell under test may be compared with the magnitude of corresponding components in the equivalent circuit of a similar fuel cell that is know to have no fault conditions, or is known to have one or more fault conditions. Such a comparison may be used to identify fault conditions in the fuel cell under test.

The system shown in FIG. 4 adjusts the current demand of the load to produce a periodic variation in net load to the fuel cell while measuring the impedance of the fuel cell. The load 62 may be comprised of resistive elements selectively activated and controlled by switching devices such as metallic oxide semi-conductor field effect transistors (MOSFETs) (not shown), Bipolar Junction Transistors or integrated gate Bipolar Junction Transistors, for example. Thus, the control signal may be used to control the MOSFETs to cause the current sunk by the load 62 to be varied. The system shown in FIG. 4 may be useful in situations where a fuel cell is to be tested during manufacturing or where the fuel cell may be removed from its application and connected to a diagnostic apparatus of which the components shown in FIG. 4 other than the fuel cell 64 may be components. The system may be employed for quality control purposes during manufacturing, for example.

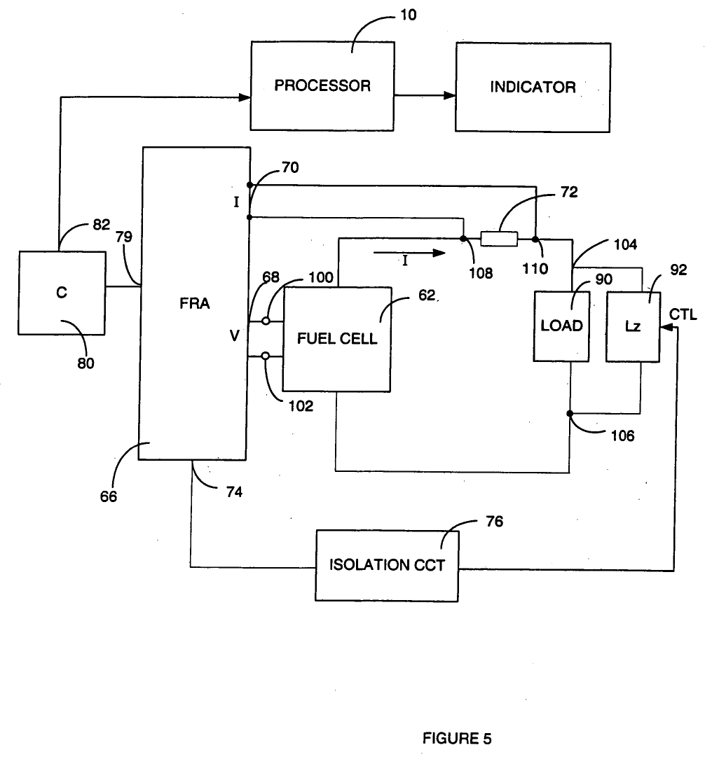

Another implementation for measuring impedance of the fuel cell 64 is shown in FIG. 5. Generally, this system is similar to the system shown in FIG. 4 and like components are designated with the same numerical reference numbers. The difference in FIG. 5 is that the load includes a fixed load 90 and a perturbation load 92 coupled to the fixed load 90 in this embodiment, by a parallel-connection. The perturbation load is controlled by the control signal and may include MOSFETs like the load 62 described in FIG. 4. With the system shown in FIG. 5, the current demand of the perturbation load coupled to the fixed load 90 is varied to produce a periodic variation in net load to the fuel cell, while the impedance of the fuel cell is being measured. The system shown in FIG. 5 may also be used for quality control during manufacturing but it has an additional advantage that it may be scaled down and implemented in a handheld device, for example, having terminals 100 and 102 for connection to the fuel cell and terminals 104 and 106 for connection to the load 90, and terminals 108 and 110 for connection to a current sensing resistor in the load circuit. In such an embodiment, the frequency response analyzer 66, computer 80, processor 10 and isolation circuit 76 may be integrated into a miniature processor circuit programmed to execute the process shown in FIG. 3 and to execute the functions of the frequency response analyzer 66 and computer 80 shown in FIG. 5, or a more limited set of functions such as measuring impedance at only a few frequencies, such as one or two frequencies within ranges associated with different fault conditions. Such a miniature processor circuit may alternatively be included within a casing of the fuel cell itself and the casing may have one or more externally viewable indicators controlled by the processor circuit to indicate faults within the fuel cell. The miniature processor circuit may be analog or digital. An analog implementation may include a lock-in amplifier, for example.

The invention may be used to detect fault conditions in fuel cells during design, manufacturing, testing and ongoing operation.

During the design of a fuel cell, substantial testing is often performed to determine the efficiency, ease of manufacture and commercial utility of the design. During such tests, the fuel cell may be subjected to extreme conditions (environmental, load, water supply, fuel supply, oxidant supply conditions, etc.) intended to ensure that the fuel cell is capable of operating in less than ideal circumstances. The present invention may be used, periodically or between tests, to determine whether the fuel cell has developed a fault. If any fault conditions are detected, further testing may be stopped, or other appropriate action may be undertaken to repair the fuel cell or to conduct tests that will not be affected by the detected fault.

The present invention may be implemented in a control loop. For example, during testing or ongoing use of a fuel cell, the present invention may be used to continuously monitor selected impedance spectrum properties of the fuel cell in response to the load on the fuel cell. The impedance spectrum property may then be compared with known fault conditions for those properties and the testing or use of the fuel cell may be stopped to permit appropriate action to be taken. Such action may include repairing the fuel cell, replacing it or continuing testing or use of the fuel cell is a manner that will not be affected by the detected fault.

Alternatively, the control loop may be implemented to periodically conduct a test of the fuel cell using a controlled load condition, as described above. Such testing may be done periodically when the fuel cell is not otherwise being used. The performance of such tests may be automated and the use of the fuel cell may be interrupted if a fault condition is detected.

During the manufacturing of fuel cells, the present invention may be used to check the quality of newly manufactured fuel cells. The invention offers a fast and non-destructive method of identifying potential defects in the fuel cells that may be used to identify and repair defective fuel cells before they are put into use.

While specific embodiments of the invention have been described and illustrated, such embodiments should be considered illustrative of the invention only and not as limiting the invention.

We claim:

1. An apparatus for identifying fault conditions in a fuel cell or fuel cell component, the apparatus comprising:
(a) an impedance spectrum input for receiving an impedance spectrum relating to the fuel cell;
(b) a processor coupled to the input for comparing the impedance spectrum with at least part of a fault criteria, wherein the processor determines that a fault condition exists when one or more properties of the impedance spectrum meets the fault criteria; and
(c) an alarm output for providing a fault condition signal when a fault condition exists.

2. The apparatus of claim 1 wherein the processor further has a fault criteria input for receiving the fault criteria.

3. The apparatus of claim 2 wherein the fault criteria are stored on a computer readable medium readable by a media reader and wherein the media reader is coupled to the fault criteria input for providing the fault criteria to the processor.

4. The apparatus of claim 1 wherein the alarm output is coupled to an alarm annunciator that is responsive to the fault condition signal to indicate when a fault condition exists.

5. The apparatus of claim 4 wherein the annunciator is selected from the group comprising: a visible indicator, an audible alarm and a display readable by an observer.

6. The apparatus of claim 4 wherein the fault condition signal is indicative of the nature of fault condition, and wherein the annunciator provides different indications in response to different fault conditions.

7. The apparatus of claim 4 wherein the fault condition signal is indicative of the nature of the fault condition, and wherein, in response to the fault condition signal, the apparatus is used to take action to remove or reduce the fault or alter the state of the fuel cell system in an appropriate way.

8. The apparatus of claim 1 wherein the processor is a comparator.

9. The apparatus of claim 1 wherein the processor is includes a plurality of comparators.

10. The apparatus of claim 1 further comprising an impedance spectrum measurement circuit coupled to the impedance spectrum input to provide the impedance spectrum.

11. The apparatus of claim 1 wherein the fault criteria include an impedance relative to a reference impedance relating a plurality of frequencies.

12. The apparatus of claim 11 wherein the plurality of frequencies includes about 5 Hz and about 10 kHz.

13. The apparatus of claim 1 wherein the fault criteria include impedances relative to reference impedances in a frequency range of about 0.5 Hz to about 100 kHz.

14. The apparatus of claim 1 wherein the fault criteria include impedances relative to reference impedances in a frequency range of about 0.5 Hz to about 100 Hz.

15. The apparatus of claim 1 wherein the apparatus is designed for use with a PEMFC and wherein the fault criteria include impedances relative to reference impedances in frequency range of about 0.5 Hz to about 100 kHz for identifying dehydration effects and include impedances relative to reference impedances in frequency range of about 0.5 Hz to about 100 Hz for identifying flooding effects.

16. The apparatus of claim 10 wherein the impedance spectrum measurement circuit includes:
(d) an impedance measuring device having
(i) a control signal output for providing a control signal to the fuel cell;
(ii) a voltage input for measuring the voltage across fuel cell; and
(iii) a current input for receiving a measure of current flowing through a current sensing element coupled in series with the fuel cell;
(e) a computer coupled to the impedance measuring device, wherein the computer is programmed to calculate the impedance spectrum, wherein the computer is coupled to the impedance spectrum input to provide the calculated impedance spectrum to the processor; and
(f) a load for coupling to the fuel cell, wherein the load is responsive to the control signal to vary the current drawn from the fuel cell.

17. The claim of claim 16 wherein the impedance measuring device is a frequency response analyzer.

18. The claim of claim 16 wherein the impedance measuring device is a locking amplifier.

19. The claim of claim 16 wherein the current sensing element is a resistor.

20. The claim of claim 16 wherein the current sensing element is a Rogowski coil.

21. The claim of claim 16 wherein the current sensing element is a current transformer.

22. The apparatus of claim 16 wherein the load draws a time-varying current from the fuel cell, and wherein the frequency of the time-varying current corresponds to the control signal.

23. The apparatus of claim 16 wherein the load is a perturbation load, and wherein the perturbation load is coupled to the fuel cell in conjunction with a fixed load such that both the perturbation load and the fixed load draw current from the fuel cell.

24. The apparatus of claim 16 wherein the load includes one or more resistive elements controlled by one or more switching elements.

25. The apparatus of claim 16 wherein the switching elements are transistors.

26. The apparatus of claim 16 further comprising an isolation circuit coupled to the control signal output for electrically isolating the control signal output from the fuel cell.

27. The apparatus of claim 16 wherein further comprising:
(g) load connection terminals for coupling the load to the fuel cell;
(h) voltage connection terminals for coupling the voltage input to the fuel cell; and
(i) current connection terminals for coupling the current input across the current sensing element.

28. The apparatus of claim 27 wherein the load is a perturbation load, and wherein the perturbation load is coupled to the fuel cell in conjunction with a fixed load such that both the perturbation load and the fixed load draw current from the fuel cell.

29. The apparatus of claim 27 wherein the apparatus is assembled in a portable housing and wherein the load connection terminals, voltage connection terminals and current connection terminals may be coupled to an external fuel cell.

30. The apparatus of claim 27 wherein the apparatus is assembled integrally with the fuel cell.

31. The apparatus of claim 30 wherein the fuel cell is a PEMFC.

32. The apparatus of claim 31 wherein the fault criteria include impedances relative to reference impedances in frequency range of about 0.5 Hz to about 100 kHz.

33. The apparatus of claim 31 wherein the fault criteria include an impedance relative to a reference impedance relating a plurality of frequencies.

34. The apparatus of claim 33 wherein the plurality of frequencies includes about 5 Hz and about 10 kHz.

35. The apparatus of claim 31 wherein the fault criteria include impedances relative to reference impedances in frequency range of about 0.5 Hz to about 100 Hz.

36. The apparatus of claim 31 wherein the fault criteria include impedances relative to reference impedances in frequency range of about 0.5 Hz to about 100 kHz for identifying dehydration effects and include impedances relative to reference impedances in frequency range of about 0.5 Hz to about 100 Hz for identifying flooding effects.

37. In a system incorporating a fuel cell or a fuel cell component, an apparatus for identifying faults in the fuel cell or fuel cell component, the apparatus comprising:
(a) an impedance spectrum input for receiving an impedance spectrum relating to the fuel cell;
(b) a processor coupled to the input for comparing the impedance spectrum with at least part of a fault criteria, wherein the processor determines that a fault condition exists when one or more properties of the impedance spectrum meets the fault criteria; and
(c) an output for providing a fault condition signal when a fault condition exists,
wherein the system is responsive to the fault condition signal to stop or modify usage of the fuel cell when a fault condition exists.

38. The apparatus of claim 37 wherein the system is a fuel cell testing system and wherein the system is configured to stop testing of the fuel cell in response to the fault condition signal.

39. A method of identifying a fault condition in a fuel cell or a fuel cell component comprising:
(a) receiving an impedance spectrum relating to the fuel cell;
(b) selecting an aspect of the impedance spectrum for comparison with at least part of a fault criteria;
(c) comparing the selected aspect of the impedance spectrum with a corresponding portion of the fault criteria; and
(d) if the selected aspect of the impedance spectrum meets the fault criteria, then providing a fault condition signal.

40. The method of claim 39 wherein the fault criteria include criterion relevant to different fault conditions and wherein the fault condition signal identifies one or more existing fault conditions.

41. The method of claim 39 further comprising:
(i) applying a time varying load to the fuel cell, wherein the load has a selected frequency; and
(ii) measuring an impedance property of the fuel cell at the selected frequency to calculate the impedance spectrum.

42. The method of claim 41 wherein steps (i) and (ii) are repeated across a range of frequencies to provide an impedance spectrum across the range of frequencies.

43. The method of claim 41 wherein the impedance spectrum is an individual measured impedance value.

44. The method of claim 41 wherein the impedance spectrum is a ratio of a measured impedance value to a reference impedance value.

45. The method of claim 41 wherein the impedance spectrum is an individual measured phase value.

46. The method of claim 41 wherein the impedance spectrum is a difference between a measured phase value and a reference phase value.

47. The method of claim 41 wherein the impedance spectrum is a ratio of a measured phase value to a reference phase value.

48. The method of claim 41 wherein the impedance spectrum is a range of measured impedance values across a range of frequencies.

49. The method of claim 41 wherein the impedance spectrum is a range of measured phase values across a range of frequencies.

50. The apparatus of claim 41 wherein the fuel cell is a PEMFC.

51. The apparatus of claim 50 wherein the fault criteria include an impedance relative to a reference impedance relating a plurality of frequencies.

52. The apparatus of claim 51 wherein the plurality of frequencies includes about 5 Hz and about 10 kHz.

53. The apparatus of claim 50 wherein the fault criteria include impedances relative to reference impedances in frequency range of about 0.5 Hz to about 100 kHz.

54. The apparatus of claim 50 wherein the fault criteria include impedances relative to reference impedances in frequency range of about 0.5 Hz to about 100 Hz.

55. The apparatus of claim 50 wherein the fault criteria include impedances relative to reference impedances in frequency range of about 0.5 Hz to about 100 kHz for identifying dehydration effects and include impedances relative to reference impedances in frequency range of about 0.5 Hz to about 100 Hz for identifying flooding effects.
